(19) United States
(12) Patent Application Publication
(10) Pub. No.: US 2017/0119208 A1
(43) Pub. Date: May 4, 2017

(54) BAKEWARE DEVICE WITH AN OIL DISCHARGE STRUCTURE

(71) Applicant: Yu-Yuan Lin, Tainan City (TW)

(72) Inventor: Yu-Yuan Lin, Tainan City (TW)

(73) Assignee: Uni-Splender Corp., Tainan City (TW)

(21) Appl. No.: 14/929,355

(22) Filed: Nov. 1, 2015

(51) Int. Cl. A47J 37/01

(52) U.S. Cl. CPC A47J 37/01

(57) ABSTRACT

A bakeware device includes bakeware having an oil discharge channel and a first pivotal portion pivotably connected to a second pivotal portion of a base having an oil pan. A positioning block is slideably mounted in the first pivotal portion and includes a tooth disengageably engages with at least one toothed section of the second pivotal portion. The tooth includes an inclined guiding face and a stop face opposite to the inclined guiding face. A spring biases the tooth to engage with the at least one toothed section of the second pivotal portion. A button is mounted to the second pivotal portion and includes an operative portion and a pressing portion protruding from the operative portion and abutting the positioning block. When the operative portion of the button is pressed, the tooth of the positioning block disengages from the at least one toothed section of the second pivotal portion.

### BACKGROUND OF THE INVENTION

The present invention relates to a bakeware device with an oil discharge structure and, more particularly, to a bakeware device including bakeware whose inclination angle can easily be adjusted and positioned.

Bakeware generally includes a lower pan and an upper pan pivotable relative to the lower pan between an open position and a closed position. A heating device is mounted to an inner side of each of the upper and lower pans. Food placed between the upper and lower pans in the closed position can be heated by the heating devices. The bakeware is generally actuated by electricity. To provide healthy food and to increase the taste, an oil discharge hole is provided in the lower pan for discharging grease and water resulting from heating of the food.

The bakeware is generally in a horizontal state while heating the food. However, the oil discharge hole cannot rapidly discharge the grease and water in time when more grease and water are generated while heating the food. To solve this problem, an electric grill having a tilting mechanism is proposed. Specifically, the electric grill includes top and bottom heating sections attached to a support structure by two hinges. A rod engages with a gear on one of the hinges to position the top and bottom heating sections at an inclination angle relative to the support structure. When more grease and water are generated after food has been heated for a period of time, a button can be pressed to disengage the rod from the gear, and the top and bottom heating portions can be lifted to a desired inclination angle relative to the support structure. Then, the press button is released to engage the rod with the gear at a different location, permitting easy discharge of grease and water. An example of such an arrangement is disclosed in U.S. Pat. No. 7,514,655.

However, the user has to press the press button with one hand and grip the top and bottom heating sections for lifting purposes with the other hand, leading to inconvenience during cooking.

### BRIEF SUMMARY OF THE INVENTION

An objective of the present invention is to provide a bakeware device permitting adjustment and positioning of an inclination angle of bakeware for rapidly discharge oil and grease while permitting convenient operation.

A bakeware device according to the present invention includes bakeware having an oil discharge channel and first and second lateral sides. The bakeware further includes a first pivotal portion on the first lateral side thereof. The first pivotal portion includes a first side and a first annular wall protruding along a periphery of the first side and extending in a longitudinal direction. A receiving space is defined between the first side and the first annular wall. A base is mounted below the bakeware and includes a top face and first and second lateral sides. An oil pan is disposed in the top face of the base and is aligned with the oil discharge channel. The base further includes a second pivotal portion on the first lateral side thereof. The second lateral side of the base is pivotably connected to the second lateral side of the bakeware. The second pivotal portion includes a second side and a second annular wall protruding along a periphery of the second side and extending in the longitudinal direction. The second annular wall of the second pivotal portion includes an inner peripheral face having at least one toothed portion with a plurality of positioning teeth. Each of the plurality of positioning teeth includes an inclined guiding face and a stop face opposite to the inclined guiding face. A positioning device is mounted to the first and second pivotal portions. The positioning device includes a positioning block, a spring, an axle, and a button. The positioning block is mounted in the receiving space of the first pivotal portion and is movable in the longitudinal direction. The positioning block includes a first face and a second face opposite to and spaced from the first face in the longitudinal direction. The second face of the positioning block includes a tooth having an inclined guiding face and a stop face opposite to the inclined guiding face of the tooth. The tooth on the second face of the positioning block disengageably engages with the at least one toothed section of the second pivotal portion. The spring biases the tooth on the second face of the positioning block to engage with the at least one toothed section of the second pivotal portion. The axle extends through the second pivotal portion, the positioning block, and the first pivotal portion to pivotably connect the first pivotal portion and the second pivotal portion. The button is mounted to the second pivotal portion and includes an operative portion and a pressing portion protruding along a periphery of the operative portion and abutting the second face of the positioning block. When the operative portion is pressed, the tooth on the second face of the positioning block disengages from the at least one toothed section of the second pivotal portion.

The first pivotal portion can further include at least one guiding projection on the inner periphery of the first annular wall thereof. The positioning block can further include at least one guiding groove. The at least one guiding projection of the first pivotal portion is slideably received in the at least one guiding groove of the positioning block, such that the positioning block is slideable relative to the first pivotal portion in the longitudinal direction.

In an example, the at least one toothed section of the second pivotal portion includes a plurality of toothed sections spaced from each other in a circumferential direction about the longitudinal direction. The second face of the positioning block includes a plurality of stops. Each stop of the positioning block restricts the inclination angle of the bakeware by abutting against an end of one of the toothed sections of the second pivotal portion.

A first coupling peg can be formed on a central portion of the first side of the first pivotal portion and includes a coupling hole. A second coupling peg can be formed on a central portion of the second side of the second pivotal portion and includes a through-hole. The positioning block can further include a through-hole formed in a central portion thereof and extending from the first face through the second face. The axle extends through the through-hole of the second coupling peg of the second pivotal portion, the through-hole of the positioning block, and the coupling hole of the first coupling peg of the first pivotal portion.

The first pivotal portion can further include a first engagement portion formed on the first side thereof and surrounding the first coupling peg. The positioning block can further include a second engagement portion formed on the first face and surrounding the through-hole of the positioning block. The spring can be a compression spring mounted between the first side of the first pivotal portion and the first face of the positioning block and includes two ends respectively mounted to the first engagement portion of the first pivotal portion and the second engagement portion of the positioning block.

The bakeware can include an upper pan and a lower pan. A handle is mounted to an end of each of the upper and lower pans. The upper and lower pans are movable relative to each other between an open position and a closed position. A heating device is adapted to be mounted to an inner side of each of the upper and lower pans. The oil discharge channel is disposed in a rear end of the lower pan. The lower pan includes a bottom face having at least one protrusion. The top face of the base abuts the at least one protrusion of the lower pan when the bakeware is in a horizontal state. The first pivotal portion is disposed on one of two opposite lateral sides of the lower pan.

In an example, a wall is formed on the second side of the second pivotal portion and surrounds the second coupling peg of the second pivotal portion. The second pivotal portion further includes a through-hole formed between the wall and the second coupling peg. The pressing portion extends through the through-hole of the second pivotal portion. The wall of the second pivotal portion includes at least one engagement groove. The button includes at least one hook. The at least one hook of the button engages with the at least one engagement groove of the second pivotal portion.

The present invention will become clearer in light of the following detailed description of illustrative embodiments of this invention described in connection with the drawings.

### DESCRIPTION OF THE DRAWINGS

FIG. 1 is an exploded, perspective view of a bakeware device according to the present invention.

FIG. 1A is an enlarged view of a circled portion of FIG. 1.

FIG. 1B is an enlarged view of another circled portion of FIG. 1.

FIG. 1C is an enlarged view of a further circled portion of FIG. 1.

FIG. 2 is a perspective view of the bakeware device of FIG. 1 after assembly.

FIG. 3 is a side view of the bakeware of FIG. 2.

FIG. 3A is an enlarged view of a circled portion of FIG. 3.

FIG. 4 is an enlarged, cross sectional view of a portion of the bakeware device according to the present invention, with a button not pressed.

FIG. 5 is a view similar to FIG. 4, with bakeware of the bakeware device lifted and with a positioning block moved.

FIG. 6 is a side view of the bakeware device, with the bakeware lifted.

FIG. 6A is an enlarged view of a circled portion of FIG. 6.

FIG. 7 is a view similar to FIG. 5, with the bakeware lifted and with the bakeware positioned.

FIG. 8 is a view similar to FIG. 7, with the button pressed.

### DETAILED DESCRIPTION OF THE INVENTION

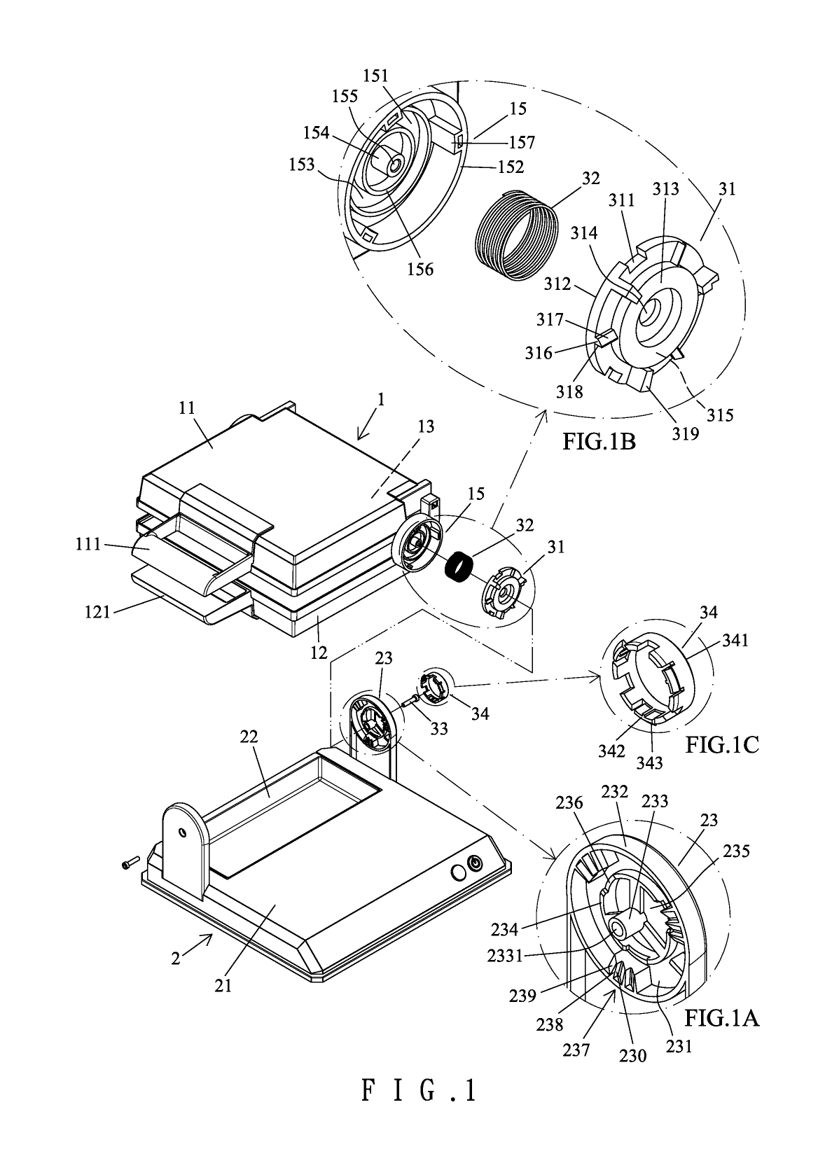

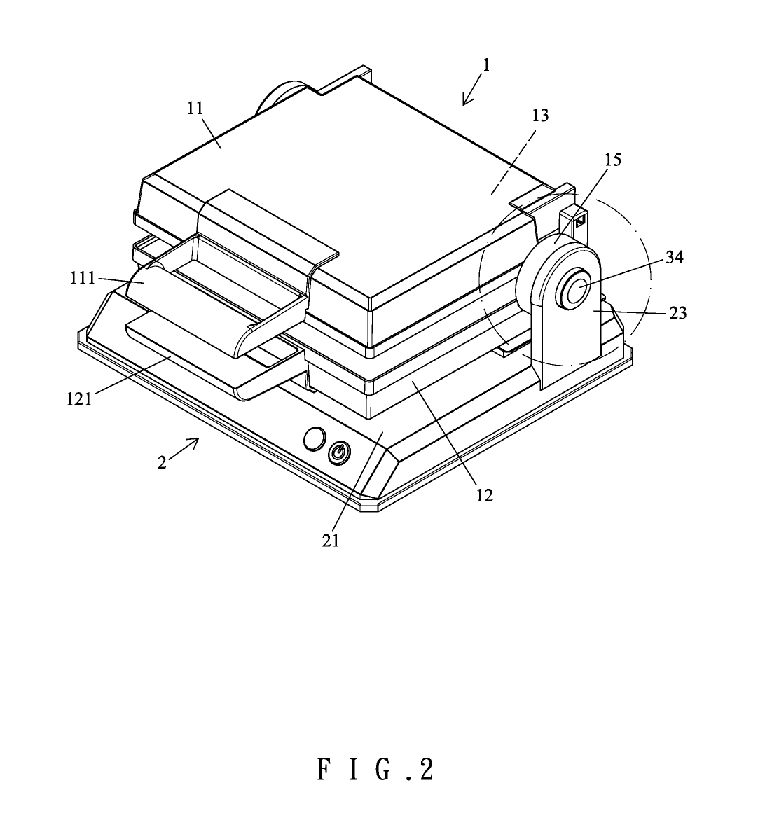

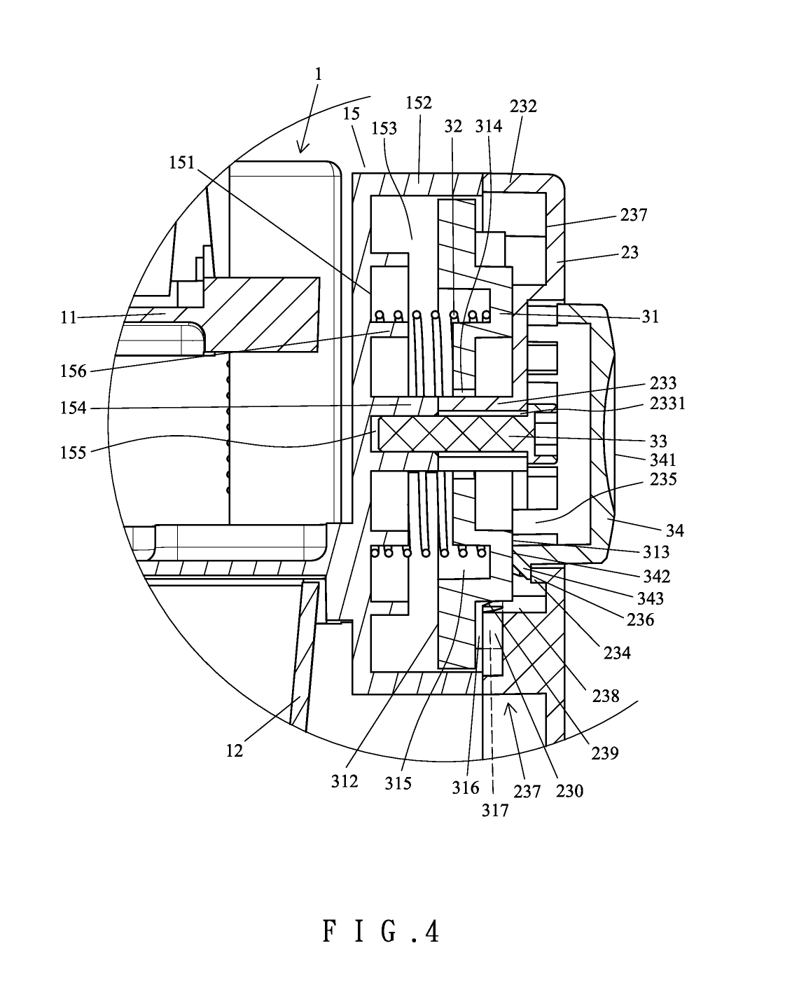

With reference to FIGS. 1-4, a bakeware device according to the present invention includes bakeware 1, a base 2, and a positioning device 3. The bakeware 1 includes an upper pan 11 and a lower pan 12. The upper and lower pans 11 and 12 are movable relative to each other between an open position and a closed position. A handle 111, 121 is mounted to a front end of each of the upper and lower pans 11 and 12. A heating device is mounted to an inner side of each of the upper and lower pans 11 and 12 for heating food placed between the upper and lower pans 11 and 12. An oil discharge channel 13 is disposed in a rear end of the lower pan 12. The lower pan 12 includes a bottom face having at least one protrusion 14.

The bakeware 1 further includes first and second lateral sides. The first lateral side of the bakeware 1 includes a first pivotal portion 15 having a first side 151 and a first annular wall 152 protruding along a periphery of the first side 151 and extending in a longitudinal direction. A receiving space 153 is defined between the first side 151 and the first annular wall 152. A first coupling peg 154 is formed on a central portion of the first side 151 of the first pivotal portion 15 and includes a coupling hole 155. The first pivotal portion 15 further includes a first engagement portion 156 formed on the first side 151 thereof and surrounding the first coupling peg 154. The first pivotal portion 15 further includes at least one guiding projection 157 on the inner periphery of the first annular wall 152 thereof.

The base 2 is mounted below the bakeware 1 and includes a top face 21 and first and second lateral sides. An oil pan 22 is disposed in the top face 21 of the base 2 and is aligned with the oil discharge channel 13. A second pivotal portion 23 is provided on the first lateral side of the base 2. The second lateral side of the base 2 is pivotably connected to the second lateral side of the bakeware 1. The second pivotal portion 23 includes a second side 231 and a second annular wall 232 protruding along a periphery of the second side 231 and extending in the longitudinal direction. A second coupling peg 233 is formed on a central portion of the second side 231 of the second pivotal portion 23 and includes a through-hole 2331. A wall 234 is formed on the second side 231 of the second pivotal portion 23 and surrounds the second coupling peg 233 of the second pivotal portion 23. A through-hole 235 is formed between the wall 234 and the second coupling peg 233. The wall 234 of the second pivotal portion 23 includes at least one engagement groove 236. The second annular wall 232 of the second pivotal portion 23 includes an inner peripheral face having at least one toothed portion 237. In the form shown, the second annular wall 232 includes three toothed portions 237 spaced from each other by 120° in a circumferential direction about the longitudinal direction. Each toothed portion 237 includes a plurality of positioning teeth 238. Each positioning tooth 238 includes an inclined guiding face 239 and a stop face 230 opposite to the inclined guiding face 239.

The positioning device 3 is mounted to the first and second pivotal portions 15 and 23. The positioning device 3 includes a positioning block 31, a spring 32, an axle 33, and a button 34. The positioning block 31 is substantially annular and is mounted in the receiving space 153 of the first pivotal portion 15. The positioning block 31 further includes at least one guiding groove 311. The at least one guiding projection 157 of the first pivotal portion 15 is received in the at least one guiding groove 311 of the positioning block 31. The positioning block 31 is slideable relative to the first pivotal portion 15 in the longitudinal direction.

The positioning block 31 further includes a first face 312 and a second face 313 opposite to and spaced from the first face 312 in the longitudinal direction. A through-hole 314 is formed in a central portion of the positioning block 31 and extends from the first face 312 through the second face 313. The positioning block 31 further includes a second engagement portion 315 formed on the first face 312 and surrounding the through-hole 314 of the positioning block 31. The second face 313 of the positioning block 31 includes at least one tooth 316 having an inclined guiding face 317 and a stop face 318 opposite to the inclined guiding face 317 of the tooth 316. In the form shown, three teeth 316 are provided and correspond to the toothed portions 237. Each tooth 316 on the second face 313 of the positioning block 31 disengageably engages with one of the toothed sections 317 of the second pivotal portion 23. The second face 313 of the positioning block 31 includes a plurality of stops 319. Each stop 319 restricts the inclination angle of the bakeware 1 by abutting against an end of one of the toothed sections 237 of the second pivotal portion 23.

The spring 32 is a compression spring mounted between the first side 151 of the first pivotal portion 15 and the first face 312 of the positioning block 31 and includes two ends respectively mounted to the first engagement portion 156 of the first pivotal portion 15 and the second engagement portion 315 of the positioning block 31. The spring 32 biases the teeth 316 on the second face 313 of the positioning block 31 to engage with the toothed sections 237 of the second pivotal portion 23.

The axle 33 extends through the through-hole 2331 of the second coupling peg 233 of the second pivotal portion 23, the through-hole 314 of the positioning block 31, and the coupling hole 155 of the first coupling peg 154 of the first pivotal portion 15 to pivotably connect the first pivotal portion 15 and the second pivotal portion 23.

The button 34 is mounted to the second pivotal portion 23 and includes an operative portion 341 and a pressing portion 342 protruding along a periphery of the operative portion 341. In the form shown, the pressing portion 342 extends through the through-hole 235 of the second pivotal portion 23 and abuts the second face 313 of the positioning block 31. The button 34 can move in the longitudinal direction after the button 34 has been mounted to the second pivotal portion 23. The button 34 includes at least one hook 343. The at least one hook 343 of the button 34 engages with the at least one engagement groove 236 of the second pivotal portion 23 to prevent disengagement of the button 34.

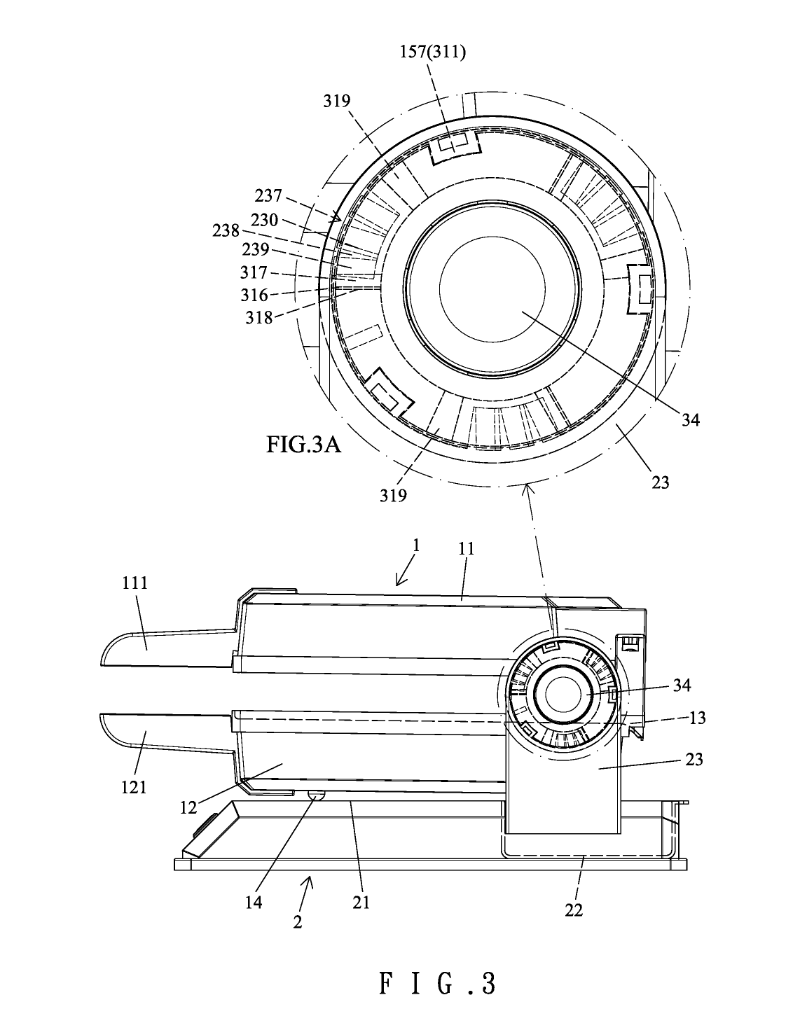

With reference to FIG. 3, when cooking food, the bakeware 1 is placed horizontally relative to the base 2. The top face 21 of the base 2 abuts the at least one protrusion 14 of the lower pan 12 to assure the bakeware 1 in the horizontal state. The grease and water generated during cooking of the food can be discharged to the oil pan 22 via the oil discharge channel 13.

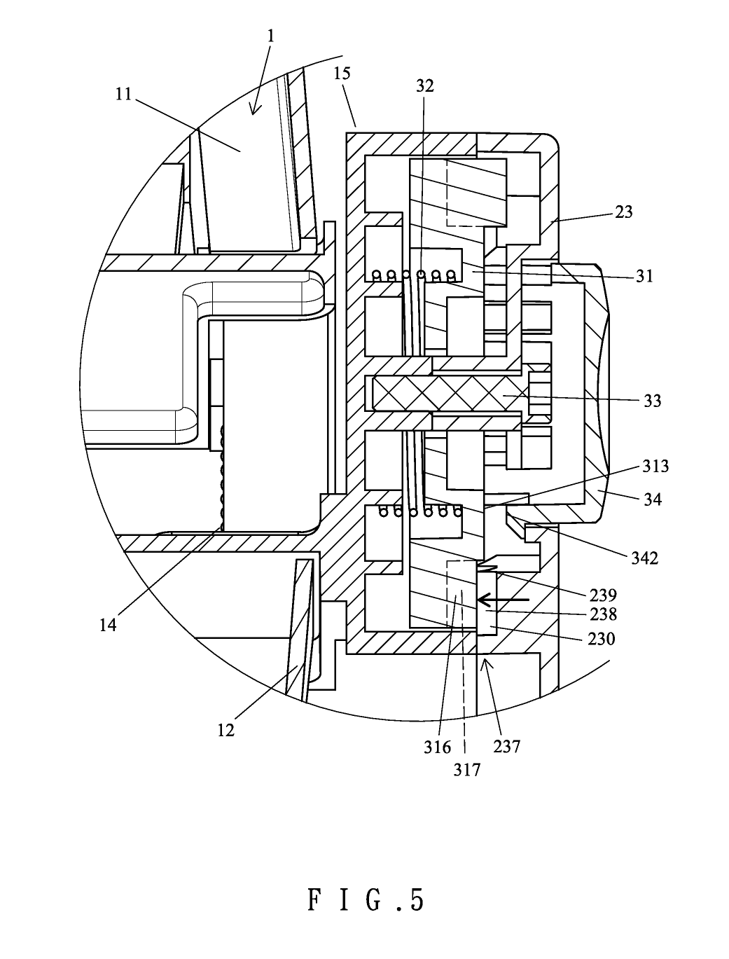

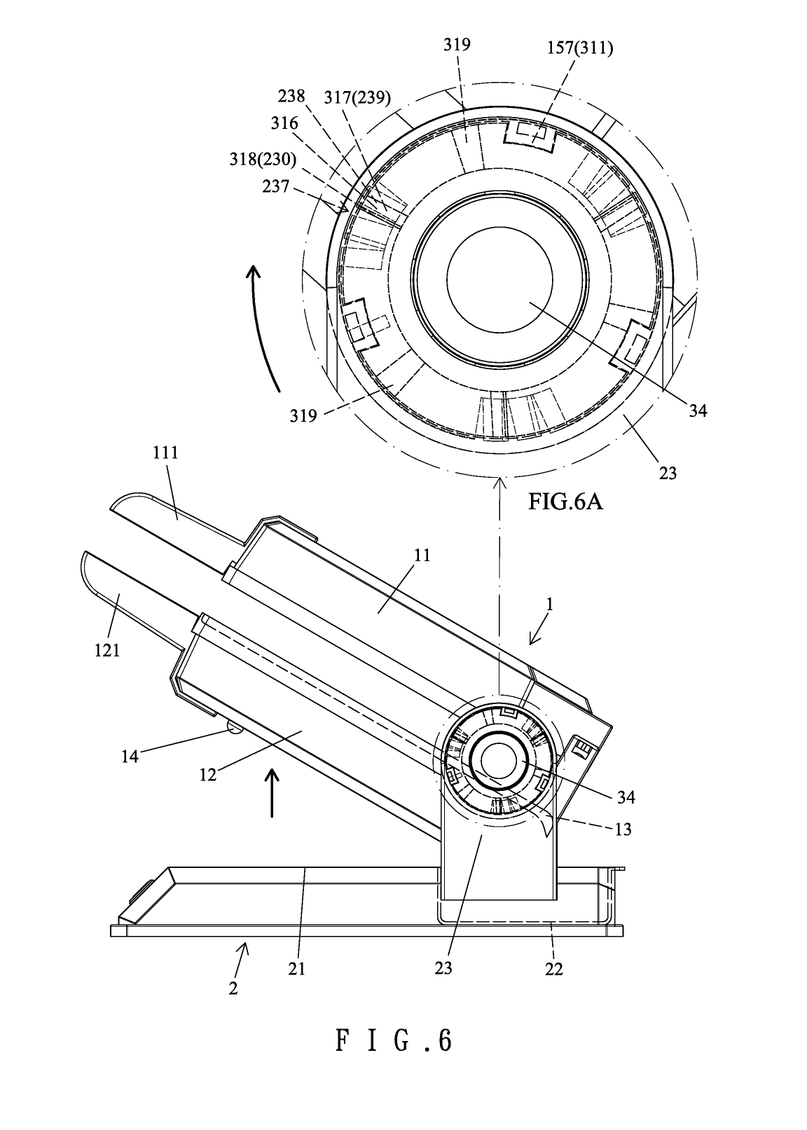

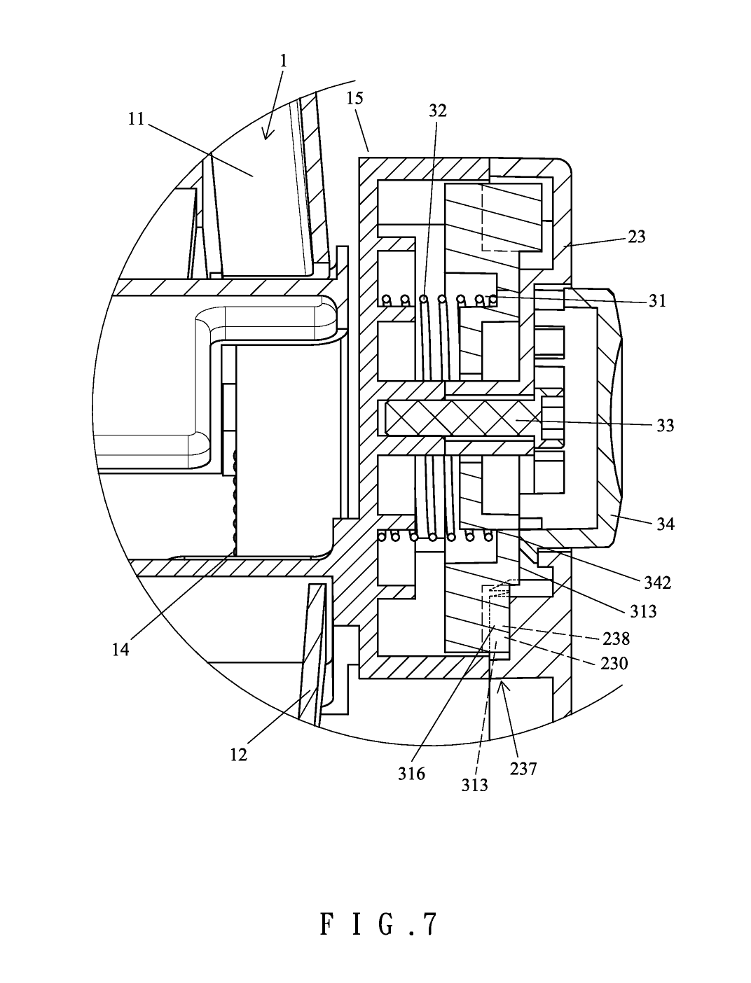

With reference to FIGS. 5-7, when more grease and water are generated and must be discharged rapidly, the bakeware 1 can be lifted by gripping the handles 111 and 121 of the bakeware 1. The first pivotal portion 15 actuates the positioning block 31 to pivot. The inclined guiding face 317 of each tooth 316 moves along the inclined guiding faces 239 of the positioning teeth 238, and the positioning block 31 can move in the longitudinal direction relative to the first engagement portion 156 (see FIG. 5) until each tooth 316 is in a desired angular position relative to the positioning teeth 238. Then, the handles 111 and 121 are released. The elastic force of the spring 32 biases the stop face 318 of each tooth 316 to press against the stop face 230 of one of the positioning teeth 238, providing a positioning effect. Thus, the bakeware 1 is retained in a desired angular position relative to the base 2 to more rapidly guide the grease and water into the oil pan 22 without destroying the flavor and taste of the food. Lifting the bakeware 1 can be achieved with a single hand to provide convenience while cooking food. Furthermore, each stop 319 of the positioning block 31 restricts the inclination angle of the bakeware 1 by abutting against an end of one of the toothed sections 237 of the second pivotal portion 23.

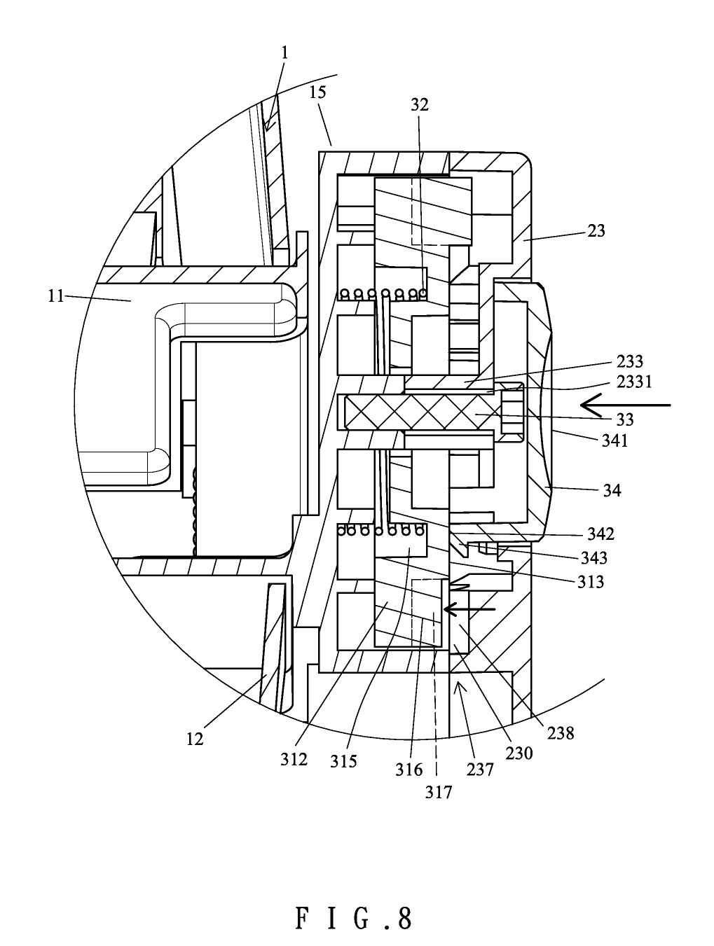

With reference to FIG. 8, when it is desired to reduce the angle between the bakeware 1 and the base 2, the user can press the pressing portion 341 of the button 34, which, in turn, presses against the positioning block 31 and, thus, moves the positioning block 31 towards the first pivotal portion 15. The teeth 316 disengage from the positioning teeth 238 of the toothed sections 237 of the second pivotal section 23, and the bakeware 1 can be pivoted relative to the base 2 in the reverse direction to the horizontal state.

In view of the foregoing, the bakeware device according to the present invention permits rapid discharge of the grease and water while providing easy operational convenience and reliable positioning. The number of the toothed sections 237 and the teeth 316 can be varied according to need. For example, the positioning block 31 can include only one tooth 316.

Although specific embodiments have been illustrated and described, numerous modifications and variations are still possible without departing from the scope of the invention. The scope of the invention is limited by the accompanying claims.

1. A bakeware device comprising:
bakeware including an oil discharge channel and first and second lateral sides, with the bakeware further including a first pivotal portion on the first lateral side thereof, with the first pivotal portion including a first side and a first annular wall protruding along a periphery of the first side and extending in a longitudinal direction, and with a receiving space defined between the first side and the first annular wall;
a base mounted below the bakeware and including a top face and first and second lateral sides, with an oil pan disposed in the top face of the base and aligned with the oil discharge channel, with the base further including a second pivotal portion on the first lateral side thereof, with the second lateral side of the base pivotably connected to the second lateral side of the bakeware, with the second pivotal portion including a second side and a second annular wall protruding along a periphery of the second side and extending in the longitudinal direction, with the second annular wall of the second pivotal portion including an inner peripheral face having at least one toothed portion with a plurality of positioning teeth, with each of the plurality of positioning teeth including an inclined guiding face and a stop face opposite to the inclined guiding face;
a positioning device mounted to the first and second pivotal portions, with the positioning device including a positioning block, a spring, an axle, and a button, with the positioning block mounted in the receiving space of the first pivotal portion and movable in the longitudinal direction, with the positioning block including a first face and a second face opposite to and spaced from the first face in the longitudinal direction, with the second face of the positioning block including a tooth having an inclined guiding face and a stop face opposite to the inclined guiding face of the tooth, with the tooth on the second face of the positioning block disengageably engaged with the at least one toothed section of the second pivotal portion, with the spring biasing the tooth on the second face of the positioning block to engage with the at least one toothed section of the second pivotal portion, with the axle extending through the second pivotal portion, the positioning block, and the first pivotal portion to pivotably connect the first pivotal portion and the second pivotal portion, with the button mounted to the second pivotal portion and including an operative portion and a pressing portion protruding along a periphery of the operative portion and abutting the second face of the positioning block, wherein when the operative portion is pressed, the tooth on the second face of the positioning block disengages from the at least one toothed section of the second pivotal portion.

2. The bakeware device as claimed in claim 1, with the first pivotal portion further including at least one guiding projection on the inner periphery of the first annular wall thereof, with the positioning block further including at least one guiding groove, with the at least one guiding projection of the first pivotal portion slideably received in the at least one guiding groove of the positioning block, and with the positioning block slideable relative to the first pivotal portion in the longitudinal direction.

3. The bakeware device as claimed in claim 1, with the at least one toothed section of the second pivotal portion including a plurality of toothed sections spaced from each other in a circumferential direction about the longitudinal direction, with the second face of the positioning block including a plurality of stops, and with each of the plurality of stops of the positioning block restricting an inclination angle of the bakeware by abutting against an end of one of the plurality of toothed sections of the second pivotal portion.

4. The bakeware device as claimed in claim 1, with a first coupling peg formed on a central portion of the first side of the first pivotal portion and including a coupling hole, with a second coupling peg formed on a central portion of the second side of the second pivotal portion and including a through-hole, with the positioning block further including a through-hole formed in a central portion thereof and extending from the first face through the second face, with the axle extending through the through-hole of the second coupling peg of the second pivotal portion, the through-hole of the positioning block, and the coupling hole of the first coupling peg of the first pivotal portion.

5. The bakeware device as claimed in claim 4, with the first pivotal portion further including a first engagement portion formed on the first side thereof and surrounding the first coupling peg, with the positioning block further including a second engagement portion formed on the first face and surrounding the through-hole of the positioning block, with the spring being a compression spring mounted between the first side of the first pivotal portion and the first face of the positioning block and including two ends respectively mounted to the first engagement portion of the first pivotal portion and the second engagement portion of the positioning block.

6. The bakeware device as claimed in claim 1, with the bakeware including an upper pan and a lower pan, with a handle mounted to an end of each of the upper and lower pans, with the upper and lower pans movable relative to each other between an open position and a closed position, with a heating device adapted to be mounted to an inner side of each of the upper and lower pans, with the oil discharge channel disposed in a rear end of the lower pan, with the lower pan including a bottom face having at least one protrusion, with the top face of the base abutting the at least one protrusion of the lower pan when the bakeware is in a horizontal state, and with the first pivotal portion disposed on one of two opposite lateral sides of the lower pan.

7. The bakeware device as claimed in claim 4, with a wall formed on the second side of the second pivotal portion and surrounding the second coupling peg of the second pivotal portion, with the second pivotal portion further including a through-hole formed between the wall and the second coupling peg, with the pressing portion extending through the through-hole of the second pivotal portion, with the wall of the second pivotal portion including at least one engagement groove, with the button including at least one hook, with the at least one hook of the button engaged with the at least one engagement groove of the second pivotal portion.
